(19) United States
(12) Patent Application Publication
(10) Pub. No.: US 2001/0029614 A1
(43) Pub. Date: Oct. 11, 2001

(54) Method for using internet and internet usage system

(76) Inventor: Junichi Ohgo, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/828,165

(22) Filed: Apr. 9, 2001

(30) Foreign Application Priority Data
Apr. 7, 2000 (JP) P2000-107037

(51) Int. Cl. H04N 7/173

(52) U.S. Cl. 725/109

(57) ABSTRACT

A method for using the Internet includes the steps of entering character data indicating an operation desired by a user using a telephone and sending the character data to a provider's server; receiving the character data, using the provider's server, carrying out the operation desired by the user based on the character data, generating display data showing the result of the operation, and sending the display data to a broadcasting station; receiving the display data, using the broadcasting station, and radio-transmitting the display data; and radio-receiving the display data from the broadcasting station, using a television set, and showing the result of the operation on the screen of the television set, based on the display data.

### BACKGROUND OF THE INVENTION

1. Field of the Invention

The present invention relates to a method for using the Internet and an Internet usage system. More specifically, the present invention relates to a method for using the Internet without using a personal computer, and an Internet usage system without using a personal computer.

2. Description of Related Art

In general, the Internet is mainly used via a personal computer. Although television sets having an Internet terminal function have been developed, their usage is not as widespread as is the usage of personal computers since they do not have as many general purposes as personal computers and they are more expensive than normal TVs due to the additional Internet terminal function.

Also, although portable telephones, which may be connected to the Internet, have been developed, it is difficult, by using such a portable telephone, to receive the same level or comfortableness of services as a personal computer does via the Internet, since the size of the display of a mobile phone is small.

Accordingly, by using the above-mentioned conventional method for using the Internet, it is difficult for a user, who does not have a personal computer, to receive the same kind of service via the Internet as one who possesses a personal computer.

The present invention takes into consideration the above-mentioned circumstances, with an object of providing a method for using the Internet and an Internet usage system which may be utilized by a user who does not have a personal computer.

Another object of the present invention is to provide an Internet usage system which may be suitably used by a user having a telephone and a television set, without using a personal computer.

### SUMMARY OF THE INVENTION

The present invention provides a method for using the Internet, including the steps of: entering character data indicating an operation desired by a user using a telephone and sending the character data to a provider's server; receiving the character data, using the provider's server, carrying out the operation desired by the user based on the character data, generating display data showing the result of the operation, and sending the display data to a broadcasting station; receiving the display data, using the broadcasting station, and radio-transmitting the display data; and radio-receiving the display data from the broadcasting station, using a television set, and showing the result of the operation on the screen of the television set based on the display data.

In accordance with another aspect of the invention, the character data are entered and sent by the user using an Internet mail function of the telephone.

In yet another aspect of the invention, the telephone is a mobile phone.

In yet another aspect of the invention, the provider's server adds an identification code to the display data, and the television set selects the display data based on the identification code.

In yet another aspect of the invention, the display data are radiotransmitted/received via a broadcasting satellite.

The present invention also provides an Internet usage system, including: a telephone which is used to enter character data indicating an operation desired by a user and to send the character data to a provider's server; the provider's server which receives the character data from the telephone to carry out the operation desired by the user based on the character data, the provider's server generates display data showing the result of carrying out the operation and sends the display data to a broadcasting station; the broadcasting station which receives the display data from the provider's server and radiotransmits the display data; and a television set which radio-receives the display data from the broadcasting station, the television set displays the result of carrying out the operation based on the display data.

In accordance with another aspect of the invention, the telephone is provided with an Internet mail function by which the character data are entered and sent to the provider's server.

In yet another aspect of the invention, the telephone is a mobile phone in the above system.

In yet another aspect of the invention, the provider's server has a function to add an identification code to the display data, and the television set selects the display data based on the identification code.

In yet another aspect of the invention, the broadcasting station is provided with a broadcasting satellite which is capable of radio-transmitting the display data.

### BRIEF DESCRIPTION OF THE DRAWING

Some of the features and advantages of the invention have been described, and others will become apparent from the detailed description which follows and from the accompanying drawing, in which:

FIG. 1 is a block diagram showing the configuration of an Internet usage system according to an embodiment of the present invention.

### DETAILED DESCRIPTION OF THE INVENTION

The invention summarized above and defined by the enumerated claims may be better understood by referring to the following detailed description, which should be read with reference to the accompanying diagrams. This detailed description of a particular preferred embodiment, set out below to enable one to build and to use one particular implementation of the invention, is not intended to limit the enumerated claims, but to serve as a particular example thereof.

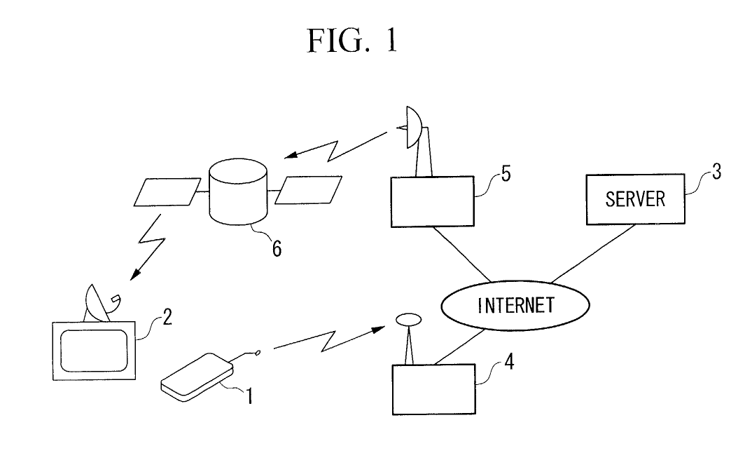

FIG. 1 is a block diagram showing the configuration of the Internet usage system according to an embodiment of the present invention. In FIG. 1, a mobile phone 1 and a television set 2 are possessed by the same user. Also, the mobile phone 1 and the television set 2 have the same identification code and such identification code is pre-registered in a provider's server 3. The provider's server 3, a telephone station 4, and a broadcasting station 5 are connected to each other via the Internet.

The mobile phone 1 has a mail sending/receiving function via the Internet (hereinafter referred to as an Internet mail function).

The television set 2 has a satellite broadcasting receiving unit (i.e., an antenna, a tuner, etc.,) to receive a satellite broadcast. The tuner selects data for the television set 2 from data received via the antenna, based on the above-mentioned identification code.

The provider's server 3 may be a computer unit including a CPU (i.e., a central processing unit) and peripheral circuits thereof. The provider's server 3 carries out various transactions via the Internet based on character data received from the mobile phone 1.

The telephone station 4 connects the mobile phone 1 to the Internet. The broadcasting station 5 radio-transmits data of the Internet via a broadcasting satellite 6.

Next, an example of the method for using the Internet according to an embodiment of the present invention using the above-mentioned system will be explained in detail.

First, a user turns on the television set 2 and selects a channel of the broadcasting station 5.

Next, the user enters character data indicating a “menu” using the Internet mail function of the mobile phone 1 and carries out an operation for sending the character data. In this manner, the mobile phone 1 sends the character data to the provider's server 3 via the telephone station 4 and the Internet.

The provider's server 3 receives the character data from the mobile phone 1. Upon receiving the character data, the provider's server 3 produces display data of the menu based on the received character data. After that the provider's server 3 generates a data packet by adding the identification code of the mobile phone 1 to the display data. The provider's server 3 sends the data packet to the broadcasting station 5 via the Internet.

The broadcasting station 5 receives the data packet from the provider's server 3. Upon receiving the data packet, the broadcasting station 5 radio-transmits the data packet via the broadcasting satellite 6.

The television set 2 radio-receives all the data packets radio-transmitted by the broadcasting station 5. Upon radio-receiving the data packet, the television set 2 selects the data packet, which has been sent to the television set 2 from the broadcasting station 5, from the radio-received data packets by comparing the identification code attached to each of the radio-received data packets with the identification code itself. Finally, the television set 2 displays on its screen the menu based on the display data of the selected data packet.

When the menu is displayed, the user enters character data, which indicate a desired operation, among the operations shown by the menu using the Internet mail function of the mobile phone 1 to carry out an operation for sending the character data. In this manner, the mobile phone 1 sends the character data to the provider's server 3 via the telephone station 4 and the Internet.

The provider's server 3 receives the character data from the mobile phone 1. Upon receiving the character data, the provider's server 3 carries out the operation desired by the user based on the received character data and generates display data showing the result of carrying out the operation. After that, the provider's server 3 produces a data packet by adding the identification code of the mobile phone 1 to the display data. Then, the provider's server 3 sends the data packet to the broadcasting station 5 via the Internet.

The broadcasting station 5 receives the data packet from the provider's server 3. Upon receiving the data packet, the broadcasting station 5 radio-transmits the data packet via the broadcasting satellite 6.

The television set 2 radio-receives all the data packets transmitted via the broadcasting station 5. Upon radio-receiving the data packet, the television set 2 selects the data packet, which has been sent to the television set 2 from the broadcasting station 5, from the radio-received data packets by comparing the identification code attached to each of the radio-received data packets with the identification code itself. Finally, the television set 2 displays the result of carrying out the above-mentioned operation based on the display data of the selected data packet.

After that, by using the same procedure, the user carries out a desired operation so that the provider's server 3 performs the operation requested by the user and the television set 2 displays the result of carrying out the operation.

According to the above-mentioned embodiment of the present invention, since the mobile phone 1 simply sends mail via the Internet and the television set 2 merely receives the satellite broadcasting, the user is simply required to turn off the switch of the television set 2 when terminates the use of the Internet after carrying out all the necessary operations.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention.

For example, in the above-mentioned embodiment, although it is defined that “the mobile phone 1 and the television set 2 have the same identification code and such identification code is pre-registered in a provider's server 3”, the present is not limited as such and an identification number may be assigned to the individual user him/herself so that the user may assign the identification number to the mobile phone 1 and the television set 2, respectively, when using the system of the present invention, and notify the identification code to the provider's server 3 by using the mobile phone 1.

In this manner, according to the present invention, the user may use an arbitrary mobile phone and a television set to use the Internet.

Also, although the mobile phone 1 having the Internet mail function is used in the above embodiment of the present invention, the present invention is not limited as such, and a general stationary type telephone (preferably a touch-tone type telephone) may also be used.

In such a case, the user connects the stationary type telephone to the provider's server 3 via a circuit prior to using the Internet and, while using the Internet, the circuit is kept connected and then cut-off after using the Internet.

In this manner, according to the present invention, the user, who does not have a mobile phone, can use the Internet.

Note that when the normal type stationary telephone is used, there is an advantage in that the response to the user's operation may be improved, as compared with the case where the mobile phone 1 having the Internet mail function is used, since the circuit is kept connected.

On the other hand, when the mobile phone 1 having the Internet mail function is used, there in an advantage in that the communication expense may be reduced as compared with the case where the normal stationary type telephone is used since the character data indicating the desired operation of a user is sent as mail and the charge is based on the number of mail units sent or of the characters (or of the packets).

The foregoing discussion, as mentioned above, is intended to be illustrative only; the invention is limited and defined only by the following claims and equivalents thereto.

1. A method for using the Internet, comprising the steps of:
entering character data indicating an operation desired by a user using a telephone and sending the character data to a provider's server;
receiving the character data, using said provider's server, carrying out the operation desired by the user based on the character data, generating display data showing the result of the operation, and sending the display data to a broadcasting station;
receiving the display data, using said broadcasting station, and radio-transmitting the display data; and
radio-receiving the display data from said broadcasting station, using a television set, and showing the result of the operation on the screen of said television set based on the display data.

2. A method for using the Internet according to claim 1, wherein the character data are entered and sent by the user using an Internet mail function of said telephone.

3. A method for using the Internet according to claim 2, wherein said telephone is a mobile phone.

4. A method for using the Internet according to claim 1, wherein said provider's server adds an identification code to the display data, and said television set selects the display data based on the identification code.

5. A method for using the Internet according to claim 1, wherein the display data are radio-transmitted/received via a broadcasting satellite.

6. An Internet usage system, comprising:
a telephone which is used to enter character data indicating an operation desired by a user and to send the character data to a provider's server;
said provider's server which receives the character data from said telephone to carry out the operation desired by the user based on the character data, said provider's server generates display data showing the result of carrying out the operation and send the display data to a broadcasting station;
said broadcasting station which receives the display data from said provider's server and radio-transmits the display data; and
a television set which radio-receives the display data from said broadcasting station, said television set displays the result of carrying out the operation based on the display data.

7. An Internet usage system according to claim 6, wherein said telephone is provided with an Internet mail function by which the character data are entered and sent to said provider's server.

8. An Internet usage system according to claim 7, wherein said telephone is a mobile phone.

9. An Internet usage system according to claim 6, wherein
said provider's server has a function to add an identification code to the display data, and said television set selects the display data based on the identification code.

10. An Internet usage system according to claim 6, wherein
said broadcasting station is provided with a broadcasting satellite which is capable of radio-transmitting the display data.
